(19) United States
(12) Patent Application Publication
(10) Pub. No.: US 2020/0394258 A1
(43) Pub. Date: Dec. 17, 2020

(54) GENERATION OF EDITED TRANSCRIPTION FOR SPEECH AUDIO

(71) Applicant: SoundHound, Inc., Santa Clara, CA (US)

(72) Inventors: Haoliang Chen, Campbell, CA (US); Junru Ren, Sunnyvale, CA (US)

(73) Assignee: SoundHound, Inc., Santa Clara, CA (US)

(21) Appl. No.: 16/442,454

(22) Filed: Jun. 15, 2019

(51) Int. Cl. G06F 17/24; G10L 15/26; G06F 17/27

(52) U.S. Cl. CPC G06F 17/24; G06F 17/277; G10L 15/265

(57) ABSTRACT

The present disclosure is intended to provide method, manufacture products, and apparatuses for generating an edited transcription of a speech audio in a SR-NLU system. A method for generating an edited transcription of a speech audio may include performing automatic speech recognition on the speech audio to produce a transcription having one or more tokens; interpreting the transcription according to each of a plurality of natural language domains to produce a plurality of interpretation results; identifying, based on the plurality of interpretation results, a natural language domain that matches the transcription; and replacing a token of interest in the transcription with a replacement token according to a predefined mapping specific to the identified natural language domain to generate the edited transcription of the speech audio.

### FIELD

Embodiments of the present disclosure generally relate to automatic speech recognition, and more particularly, to generation of an edited transcription for a speech audio in a speech recognition and natural language understanding (SR-NLU) system.

### BACKGROUND

Speech recognition and natural language understanding systems have become more prevalent in today's society. More and more everyday devices, such as appliances, vehicles, mobile devices, etc., are being equipped with speech recognition and natural language understanding capabilities. For example, a virtual assistant may be installed on these everyday devices to recognize speech audio received from a user and answer questions or carry out commands expressed using natural language. The virtual assistant may be able to give weather forecast, provide navigation information, play requested music, play requested videos, answer mathematical problems, send short message service (SMS) messages, make phone calls, etc. In other words, the virtual assistant may be developed to handle questions and commands across a set of natural language domains (simplified as “domains” hereinafter). In the field of natural language understanding, domains may be regarded as distinct sets of related capabilities, such as providing information relevant to a particular field or performing actions relevant to a specific device.

When recognizing the received speech audio, the virtual assistant may also generate corresponding transcriptions and render the transcriptions to the user in order to provide a good user experience. However, sometimes the virtual assistant may not be able to convert the received speech audio to an appropriate or satisfactory transcriptions based only on the result of speech recognition.

Therefore, it is desirable to develop a technology that is capable of generating appropriate or satisfactory transcriptions corresponding to the speech audio received from the user.

### SUMMARY

The present disclosure provides methods, manufacture products, and apparatuses for generating an edited or refined transcription of a speech audio in a SR-NLU system.

An aspect of the disclosure provides a method for generating an edited (e.g., refined) transcription of a speech audio. The method may include performing automatic speech recognition on the speech audio to produce a transcription having one or more tokens; interpreting the transcription according to each of a plurality of natural language domains to produce a plurality of interpretation results; identifying, based on the plurality of interpretation results, a natural language domain that matches the transcription; and replacing a token of interest in the transcription with a replacement token according to a predefined mapping specific to the identified natural language domain to generate the edited transcription of the speech audio.

Another aspect of the disclosure provides a non-transitory computer readable medium storing code that, if executed by one or more processors, causes the one or more processors to: perform automatic speech recognition on the speech audio to produce a transcription having one or more tokens; interpret the transcription according to each of a plurality of natural language domains to produce a plurality of interpretation results; identify, based on the plurality of interpretation results, a natural language domain that matches the transcription; and replace a token of interest in the transcription with a replacement token according to a predefined mapping specific to the identified natural language domain to generate the edited transcription of the speech audio.

A further aspect of the disclosure provides an apparatus for generating an edited transcription of a speech audio. The apparatus includes a memory and a processor to access the memory via a memory interface. The processor may be configured to: perform automatic speech recognition on the speech audio to produce a transcription having one or more tokens; interpret the transcription according to each of a plurality of natural language domains to produce a plurality of interpretation results; identify, based on the plurality of interpretation results, a natural language domain that matches the transcription; and replace a token of interest in the transcription with a replacement token according to a predefined mapping specific to the identified natural language domain to generate the edited transcription of the speech audio. The memory may store a plurality of predefined mappings each of which is respectively specific to each of the plurality of natural language domains.

### BRIEF DESCRIPTION OF THE DRAWINGS

The specific features, aspects, and advantages of the present invention will become better understood with regard to the following description and accompanying drawings where:

FIG. 1 illustrates a block diagram of a general framework implemented by a speech recognition and natural language understanding system according to some embodiments of the present disclosure.

FIG. 2 illustrates a flow chart of a method for generating an edited transcription of a speech audio according to some embodiments of the present disclosure.

FIG. 3 illustrates a set of example domains and corresponding descriptions that may be applied in a speech recognition and natural language understanding system.

FIG. 4 illustrates an example simple token replacement mapping specific to a Music domain according to some embodiments of the present disclosure.

FIG. 5 illustrates pseudo codes implementing an example programmatic mapping specific to a Super Bowl domain according to some embodiments of the present disclosure.

FIG. 6 illustrates a flow chart of a method for generating an edited transcription of a speech audio to be updated in real time according to some embodiments of the present disclosure.

FIG. 7 illustrates a block diagram of an example computer system that can implement various components of a speech recognition and natural language understanding system.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly herein. The phrase generally does not refer to the same embodiments; however, it may. The terms “comprising,” “having,” and “including” are synonymous, unless the context dictates otherwise. The phrases “A or B” and “A/B” mean “(A), (B), or (A and B).”

In the SR-NLU system presently disclosed herein, a transcription is generated from an ASR subsystem. The transcription may then be processed to refine or “edit” the transcription to replace certain tokens within the transcription. The replacements may serve to, for example, remove vulgar words or expressions from a transcription, correct formatting of numbers or other terms, and correct titles and names of people or places. As such, references to an “edited” transcription are intended refer to a transcription that has been modified by replacing certain words or tokens in the transcription to create a more refined or improved transcription.

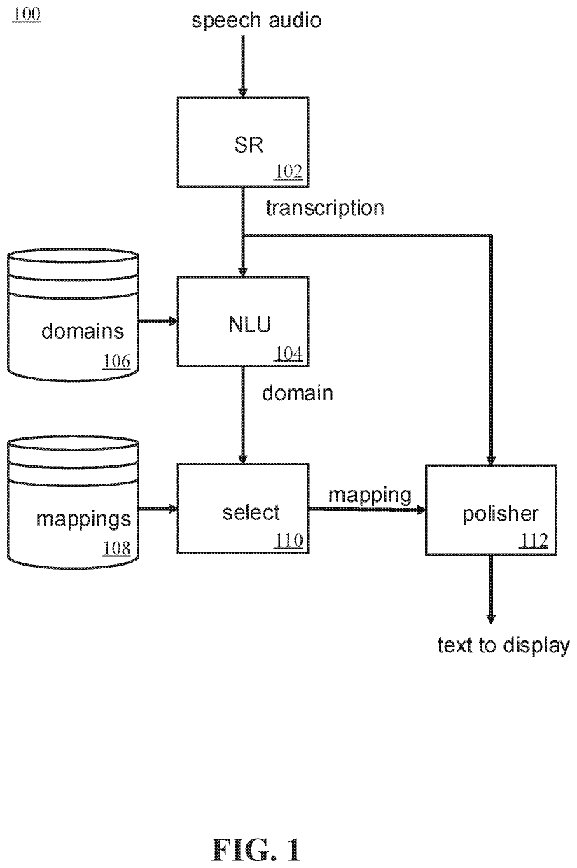

FIG. 1 is a block diagram that illustrates a general framework implemented by a speech recognition and natural language understanding (SR-NLU) system (e.g., a natural language understanding platform/server). In some instances, the SR-NLU system could be used to implement a transcription system. In some instances, the SR-NLU system could also implement at least a portion of a virtual assistant, which may further include a fulfillment subsystem and an output generation subsystem. In state of the art implementations of speech recognition and natural language understanding systems, speech recognition is typically applied first to produce a sequence of tokens or a set of token sequence hypotheses. Tokens can be alphabetic words such as English words, logographic characters such as Chinese characters, or discernable elemental units of other types of writing systems. Sometimes, this type of system is referred to as a combination of acoustic recognition and language, or linguistic, recognition. Speech recognition output is sent to the NLU system to extract the meaning of the sequence of tokens or token sequence hypotheses output by the speech recognition subsystem.

Referring to FIG. 1, the general framework 100 includes receiving speech audio that includes natural language utterances. An example of speech audio would be a recording of a user speaking the expression “I want to listen to songs of JB”. The speech audio can be received from any type of device (e.g., a mobile phone, a media player, a vehicle, etc.).

The speech audio is then analyzed by a SR subsystem 102 that converts the speech audio into a text string called a transcription, such as “I want to listen to songs of JB”.

Once the transcription is obtained, natural language understanding for the transcription is performed by an NLU subsystem 104 to extract meaning from the transcription “I want to listen to songs of JB”. Oftentimes, in order to determine the proper meaning from the transcription, the SR-NLU system may interpret the transcription according to a plurality of domains 106 and identify a specific domain that is most appropriate to interpret the transcription. The interpretation of the transcription may be different in different domains. For example, “How high is Denver” is a temperature request in a Weather domain but an altitude request in a Geography domain. For another example, “ [symbol] ” is a navigation request in the Navigation domain but a movie watching request in the Movie domain. Then, based on the extracted meaning, a corresponding action may be performed to respond to the user's demand. For example, if the SR-NLU system can determine to use a Music domain to interpret the transcription “I want to listen to songs of JB”, the SR-NLU system may understand that in the Music domain, the “JB” in the transcription is the nickname of the popular singer Justin Bieber, and thus instruct a connected music player terminal to search and play the songs of Justin Bieber.

Sometimes during or after recognizing the speech audio from the user, the transcription may be rendered to the user as text on a display for a good user experience. For example, the transcription “I want to listen to songs of JB” may be rendered to the user. However, there may be a problem if the transcription “I want to listen to songs of JB” is rendered to the user, because the word “JB” carries a vulgar meaning in Chinese culture. So, it may be desirable to replace the “JB” with its polite synonym “Justin Bieber” when rendering the transcription to the user. However, in order to implement the replacement, the SR-NLU system may need to firstly identify the specific domain that is appropriate to interpret the transcription, since the “JB” may have different meanings in a domain other than the Music domain.

As another example, when a user says “when is the pink concert”, the SR-NLU system should understand that the user is asking when is the concert of the singer “P!nk”, so a more appropriate transcription to be rendered to the user should be “when is the P!nk concert” instead of “when is the pink concert”. This means that the “pink” is to be replaced by the “P!nk” which is a more proper written form of the singer's name and has the same pronunciation as that of the “pink”. Likewise, the replacement from the “pink” to the “P!nk” is specific to the Music domain. It is obviously not proper to implement such a replacement in other domains such as a Geography domain to answer the query “show me a picture of the pink poodle motel”.

In view of the above two examples, it may be desirable and/or an attractive idea to edit the transcription of the speech audio received from the user according to the actual meaning extracted from the transcription. On the basis of such an idea, it is proposed to generate edited transcriptions by implementing token replacements specific to domains in the SR-NLU system to provide an improved user experience.

Accordingly, the SR-NLU system in FIG. 1 may further include a data storage 108 to store domain specific mappings for token replacements, a mapping selection module 110 and a transcription editor 112. According to some embodiments of the present disclosure, the NLU subsystem 104 may interpret the transcription according to each of the plurality of domains 106 to identify a specific domain that is most appropriate to interpret the transcription. Then, the mapping selection module 110 may select a mapping specific to the identified domain from the pre-stored mappings, and the transcription editor 112 may generate the edited transcription by replacing certain tokens based on the selected mapping. As a result, the edited transcription can be rendered to the user as text on a display to provide an improved user's experience.

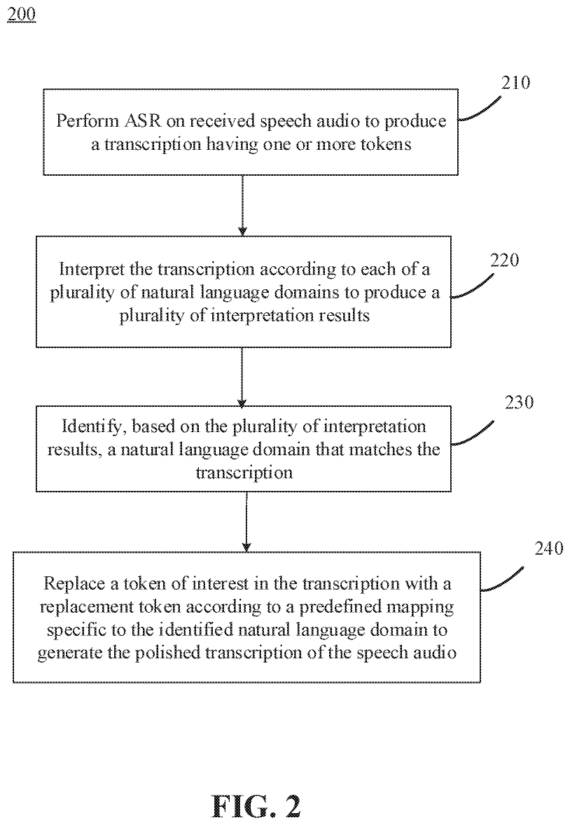

FIG. 2 illustrates a flow chart of a method 200 for generating an edited transcription of a speech audio according to some embodiments of the present disclosure. As shown in FIG. 2, the method 200 may include operations 210 to 240 and may be implemented by a virtual assistant. The virtual assistant may be an application that is installed on devices such as appliances, vehicles, mobile devices, etc. to recognize speech audio received from a user and answer questions or carry out commands expressed using natural language and derived from an interpretation of the received audio transcription. For example, the virtual assistant may implement the functions of automatic speech recognition (ASR) and natural language understanding (NLU) by interacting with an ASR processor and a cloud-based multi-domain NLU interpreting server.

At 210, the virtual assistant may perform automatic speech recognition on the speech audio to produce a transcription having one or more tokens.

Generally, an ASR processor performs spectral analysis on received audio signals and extracts features, from which the ASR processor hypothesizes multiple phoneme sequences, each having a score representing the likelihood that it is correct, given the acoustic analysis of the received audio. Then the ASR processor proceeds to tokenize phoneme sequence hypotheses into token sequence hypotheses according to a dictionary maintaining a score for each hypothesis. Tokens can be alphabetic words such as English words, logographic characters such as Chinese characters, or discernable elemental units of other types of writing systems. In other words, the virtual assistant may be applied in any language environment such as the English environment, the Chinese environment, etc. For example, when a user says “when is the pink's concert” in English in front of the virtual assistant, a transcription of “when is the pink's concert” may be produced as a result of the automatic speech recognition. Also, when a user says “ [symbol] [symbol] ” in Chinese, a transcription of “ [symbol] [symbol] ” may be produced as a result of the automatic speech recognition. Accordingly, the tokens may be encoded in different character encodings, such as American Standard Code for Information Interchange (ASCII) character encoding or Unicode character encoding.

At 220, the virtual assistant may interpret the transcription according to each of a plurality of natural language domains to produce a plurality of interpretation results.

In the field of natural language understanding, domains may be regarded as distinct sets of related capabilities, such as providing information relevant to a particular field or performing actions relevant to a specific device. The virtual assistant may be configured to handle questions and commands across a set of domains. Also, the domains applicable to the virtual assistant may be customized for various application scenarios.

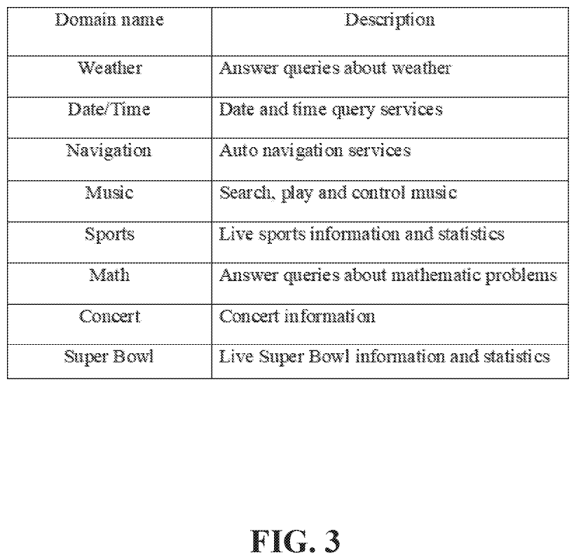

FIG. 3 illustrates a set of example domains and corresponding descriptions that may be applied in the speech recognition and natural language understanding system. As shown in FIG. 3, for example, a Weather domain is to answer queries about weather, a Date/Time domain is to provide date and time query services, a Navigation domain is to provide auto navigation services, a Music domain is to search, play and control music, a Sports domain is to give live sports information or statistics, a Math domain is to answer queries about mathematic problems, a Concert domain is to provide concert information, and the like. In fact, the domains may be developed and tailored to fit actual applications. For example, since the most popular sports event in America is the National Football League final game called the Super Bowl, a specialized domain of “Super Bowl” may be designed to provide live information or statistics about the Super Bowl.

As mentioned above, in different domains, a certain token in a transcription of a speech audio may have different meanings and need to be replaced by different replacement tokens. Therefore, in order to generate a proper edited transcription, the virtual assistant needs to identify the domain that matches the actual meaning of the transcription before making token replacements. Generally, the virtual assistant may interpret the transcription according to each of a plurality of applicable natural language domains to produce a plurality of interpretation results. Then based on the produced interpretation results, a natural language domain that matches the transcription may be determined. For example, the interpretation of the transcription may be implemented by the virtual assistant interacting with a cloud-based multi-domain NLU interpreting server.

At 230, the virtual assistant may identify the natural language domain that matches the transcription based on the plurality of interpretation results. The process of interpreting the transcription and identifying the best matching domain may be implemented by any known or future developed technologies, which is not limited in the disclosure. A simple and intuitive way is to compute a score for each of a plurality of different domains that indicates how well the transcription makes sense in that domain, then choose the domain with the best score as the best matching domain and use interpretation from that domain to produce a response for the user.

At 240, the virtual assistant may replace a token of interest in the transcription with a replacement token according to a predefined mapping specific to the identified natural language domain to generate the edited transcription of the speech audio.

As exemplified above, there may be some inappropriate tokens in the transcription directly generated by speech recognition. Therefore, it may be desirable to replace these inappropriate tokens with replacement tokens which may be more appropriate in the context of the transcription. As a certain token may have different meanings in different domains, it is proposed to perform the replacement according to a mapping specific to a natural language domain that is identified as best matching the context of the transcription.

According to embodiments of the disclosure, each domain may be configured with a predefined mapping which may be a simple token replacement mapping or a programmatic mapping. Specifically, the simple token replacement mapping may be implemented by including one-to-one token mapping entries between a predefined list of tokens of interest and a predefined list of replacement tokens, while the programmatic mapping means that the mapping between a token of interest and a replacement token may be implemented by a sequence of program codes or regular expressions.

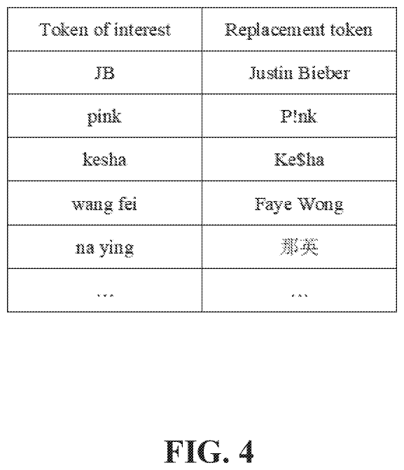

FIG. 4 illustrates an example simple token replacement mapping specific to the Music domain. For example, when a user says “I want to listen to songs of JB”, an edited transcription of “I want to listen to songs of Justin Bieber” may be generated according to the illustrated mapping of the Music domain. In particular, the virtual assistant may identify that the token “JB” is in the list of token of interest of the mapping and then replace the token “JB” with its corresponding replacement token in the list of replacement tokens. In this example, the token “JB” of interest may have a vulgar meaning and the replacement token is a polite synonym “Justin Bieber” of the token “JB” of interest. However, other types of replacements may be easily conceived to generate an edited transcription. For example, when a user says “I want to listen to songs of kesha”, an edited transcription of “I want to listen to songs of Ke$ha” may be generated. Likewise, when a user says “when is the pink concert”, an edited transcription of “when is the P!nk concert” may be generated. The replacement from the token “pink” to the token “P!nk” may be favorable, since the singer may like to spell her name “P!nk” which is pronounced as “pink”. In this example, the replacement token (e.g. “P!nk” or “Ke$ha”) has a same pronunciation as the token of interest (e.g. “pink” or “kesha”) but a more proper written form than the token of interest in the Music domain.

Also, the token of interest may be a loan word and the replacement token may be a synonym native to a language of the speech audio. For example, when a Chinese user speaks “please play songs of wang fei” to the virtual assistant in English, the virtual assistant may understand the loan word “wang fei” means the singer “ [symbol] ” whose English name is Faye Wong, and thus generate an edited transcription of “please play songs of Faye Wong” using a more appropriate English name of the singer.

In another example, when a Chinese user speaks “please play songs of na ying” to the virtual assistant in English, the virtual assistant may understand the loan word “na ying” means the singer “ [symbol] ”, and generate an edited transcription of “please play songs of [symbol] ” using a proper Chinese name of the Chinese singer. The token of interest “na ying” includes American Standard Code for Information Interchange (ASCII) characters, while the replacement token “ [symbol] [symbol] ” includes Unicode characters. That means the token of interest and the replacement token may be encoded in different character encodings.

In addition to the illustrated mapping specific to the Music domain, various mappings may be predefined for a domain to enable various types of replacements according to individualized requirements. In a Navigation domain, it may be preferable to display a road number as an Arabic number instead of a long expression derived from the pronunciation of the road number. For example, when a user says “ [symbol] [symbol] ” in Chinese, the virtual assistant may generate an edited transcription of “ [symbol] 21 [symbol] ”, which means the token “ [symbol] ” is to be replaced by the token “21”. In a Math domain, it may be more intuitive to display a mathematic expression. For example, when a user says “What is one thousand five hundred and fifty plus ten?”, the virtual assistant may generate an edited transcription of “What is 1550+10?”. For another example, when a user says “ [symbol] [symbol] ”, the virtual assistant may generated an edited transcription of “1550+10 [symbol] ”. Also, sometimes the replacement token may be an abbreviation of the token of interest in order to render a clear but simple transcription. For example, when a user asks “One mile is how many kilometers?”, an edited transcription may be “One mile is how many km?”. For another example, when a user asks “ [symbol] [symbol] ?”, an edited transcription may be “150 km [symbol] ”.

According to embodiments of the disclosure, the simple token replacement mapping may be stored as a search tree structure, and any existing or future developed searching algorithms can be applied to the search tree structure to identify the token of interest and its corresponding replacement token, which is not limited in the disclosure.

Other than the simple token replacement mapping, a programmatic mapping may be also applied to enable the virtual assistant to implement token replacements. A regular expression mapping can be considered as a type of programmatic mapping. The regular expression mapping may include a plurality of predefined mapping entries each of which consists of a regular expression and a corresponding replacement token. A regular expression may be a sequence of characters that define a search pattern for matching text. For example, the regular expression “Jo.n” matches the name John and Joan but not the name Jon or Jordan, and the regular expression “Jo.*n” matches the name John, Joan, Jon and Jordan. Any regular expression applicable to perform a desired text matching may be used in the embodiments of the disclosure. Also, how to construct a regular expression for desired text matching has been well known in the field of text matching, so the details about the construction of the regular expression will not be described in the disclosure. But it is to be noted that like the simple token replacement mapping, each domain may be configured with its own specific regular expression mappings.

According to the regular expression mapping, once a token in a transcription is identified to match a predefined regular expression, the token may be replaced by a predefined replacement token corresponding to the regular expression. For example, a predefined regular expression is “regex ([a−zA−Z]+)\1” and the corresponding replacement token is “#1”. In this example, when the virtual assistant is to generate an edited transcription, any token matching the “regex ([a−zA−Z]+)\1” will be replaced by the replacement token “#1”.

The programmatic mapping may also be implemented by program codes. Instead of predefining a replacement token corresponding to a token of interest, the replacement token may be obtained by running a sequence of program codes that take the token of interest as a parameter.

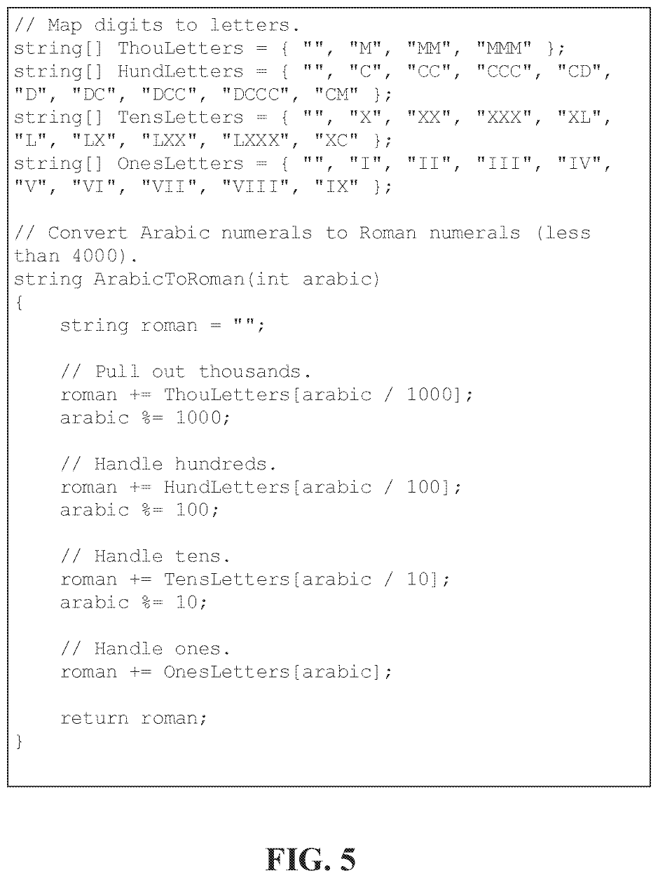

FIG. 5 illustrates pseudo codes implementing an example programmatic mapping specific to a Super Bowl domain according to some embodiments of the present disclosure. The Super Bowl domain may be specially designed for providing live information or statistics about the Super Bowl. In America, the most popular sports event is the National Football League final game, which is called the Super Bowl. It is called a bowl because of the shape of some football stadiums. By tradition, every Super Bowl is given a roman numeral. In 2019, the game is called Super Bowl LII. LII means 52 in Roman numerals. According to embodiments of the disclosure, when someone asks “where was super bowl 52”, it may desirable to generate an edited transcription of “where was Super Bowl LII”. Firstly, the virtual assistant should identify that the Super Bowl domain best matches the speech. Then because the Super Bowl domain is configured with a programmatic mapping that predefines pseudo codes as illustrated in FIG. 5 that run on any sequence of digits following the token “super bowl”, the token of “52” can be replaced by the replacement token of “LII”. The “LII” is a Roman number derived by using the token of “52” as the parameter for the pseudo codes and running the pseudo codes.

In the example, the programmatic mapping implemented by the pseudo codes is specific to the Super Bowl domain. If the speech from the user is not identified to match the Super Bowl domain, the programmatic mapping will not be utilized. For example, when someone asks “where was noodle bowl 52”, the virtual assistant may understand that the speech is not related to the Super Bowl game, so the transcription will be “where was noodle bowl 52” without any token replacements.

According to some embodiments of the disclosure, a natural language domain may be configured with both a simple token replacement mapping and a programmatic mapping. The simple token replacement mapping and the programmatic mapping may be integrated in one mapping structure, but it may be favorable to store the simple token replacement mapping and the programmatic mapping separately in a memory. By storing the simple token replacement mapping and the programmatic mapping as separate mapping structures, the token replacement according to the simple token replacement mapping and the token replacement according to the programmatic mapping may be performed simultaneously on separate processing threads, so that the efficiency of making token replacements may be improved. For example, the token replacement according to the simple token replacement mapping may be performed by searching a tree structure on one processing thread, while the token replacement according to the programmatic mapping may be performed by parsing regular expressions or running program codes on another processing thread.

According to some embodiments of the disclosure, both the simple token replacement mapping and the programmatic mapping may be dynamic mappings. For example, a system developer, an engineer, a government agency or a corporate agent may edit a predefined mapping to add, revise, or delete a mapping entry in the predefined mapping. Also, the predefined mapping may be dynamically retrieved over a network from a NLU interpreting server (e.g. a cloud-based multi-domain NLU interpreting server to which the virtual assistant is connected).

With the method for generating the edited transcription according to embodiments of the disclosure, some tokens in a transcription can be replaced by more appropriate or satisfactory replacement tokens according to the context of the transcription, so that an edited transcription can be rendered to the user to improve the user's experience. Also, the replacement tokens within the edited transcription may be tagged so as to enable rendering the edited transcription with the replacement tokens being distinguishable.

In many cases, a user may continuously speak, which means that a speech audio from the user may be updated in real time. In this situation, it may be desirable to generate the edited transcription that can be also updated in real time according to the speech audio, because the natural language domain best matching the speech audio may also change as the speech audio changes. It should be noted that the speech audio to be updated in real time may also be referred to as a streamed speech audio since the speech audio may be updated very fast and the SR-NLU system can process a very large number of audio frames every second.

Generally, the SR-NLU system may receive the speech audio continuously and analyze a frame of the speech audio periodically (e.g. every 10 ms) to detect if a new phoneme is being spoken. A normal speaking rate is about 10 phonemes per second, though some phonemes may be very short and some phonemes may be much longer. Whenever the SR-NLU system determines a new phoneme has occurred, it may consider the speech audio as an updated speech audio. Then the SR-NLU system may perform the automatic speech recognition on the updated speech audio to produce an updated transcription and detect if the updated transcription includes a new token, and generate an updated edited transcription once it is detected that the updated transcription includes the new token.

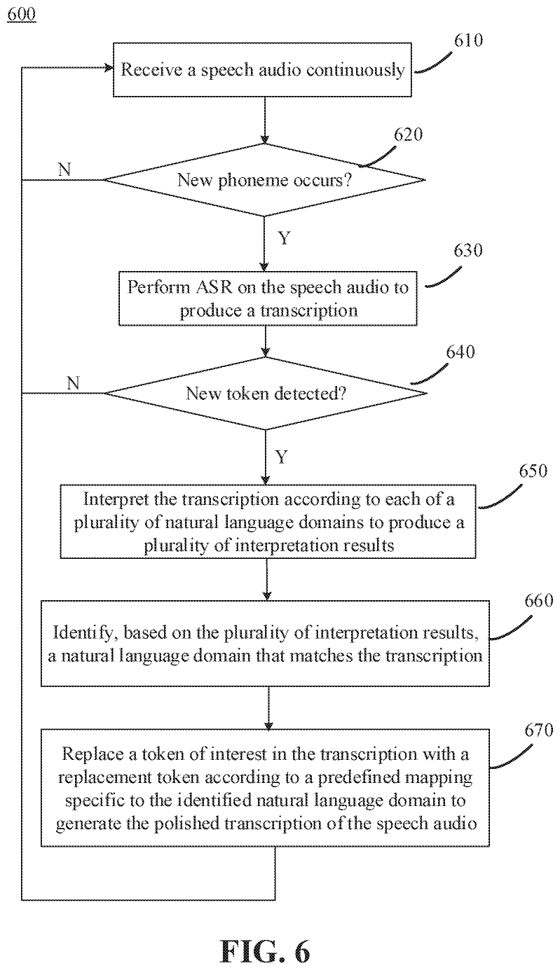

FIG. 6 illustrates a flow chart of a method 600 for generating an edited transcription of a speech audio to be updated in real time according to some embodiments of the present disclosure. The method 600 may include operations 610 to 670 implemented by, for example, a virtual assistant.

At 610, the virtual assistant may receive a speech audio continuously from a user. At 620, the virtual assistant may analyze the speech audio periodically to determine if a new phoneme has occurred. When it is determined that a new phoneme has occurred at 620, the virtual assistant may perform the automatic speech recognition on the speech audio to produce an updated transcription at 630. Then the virtual assistant may detect if the updated transcription includes a new token at 640. Once it is detected that the updated transcription includes the new token at 640, the virtual assistant may proceed to operations 650 to 670 to generate an updated edited transcription. The operations 650 to 670 are similar to operations 220 to 240, respectively, which implement the transcription interpretation, the domain identification and the token replacement, so details about these operations will not be described again.

According to the method 600 illustrated in FIG. 6, the edited transcription may be updated in real time as the received speech audio changes. For example, when the virtual assistant receives speech audio of asking “for the show tomorrow, when will it begin”, it may interpret the speech audio as a question in a Concert domain and thus may generate an edited transcription of “for the concert tomorrow, when will it begin” in which the token of interest “show” has been replaced by the replacement token “concert”. If the user continues to add more words to generate an updated speech audio of asking “for the show tomorrow, when will it begin to rain”, the virtual assistant may further interpret the updated speech audio as a question in a Weather domain and thus may generate the updated transcription of “for the show tomorrow, when will it begin” without replacing the token “show” with the token “concert”. As the user speaks, the token in the generated transcription may change from “show” to “concert” and back to “show” since the best matching domain may change due to new tokens occurring in the updated speech audio.

On the other hand, in some systems, the transcription produced by performing ASR on the received speech audio may include multiple transcription hypotheses. For example, if there is noise in the background when a user asks “for the show tomorrow, when will it begin rain”, multiple transcription hypotheses may be produced by performing ASR on the speech audio, such as “for the show tomorrow, when will it begin train”, “further show tomorrow, when will it begin to rain”, or “fourth show tomorrow, when will it beg into rain”. Therefore, in some embodiments of the disclosure, the SR-NLU system can interpret the multiple transcription hypotheses according to each of the plurality of natural language domains to identify a natural language domain that best matches actual meaning of the user's speech. In this case, the best matching domain may also change as the user speaks, because the best transcription selected from the multiple transcription hypotheses may change as the user speaks. Also, the SR-NLU system may simultaneously interpret the multiple transcription hypotheses by use of multi-threaded processing, so as to further improve the performance of the system.

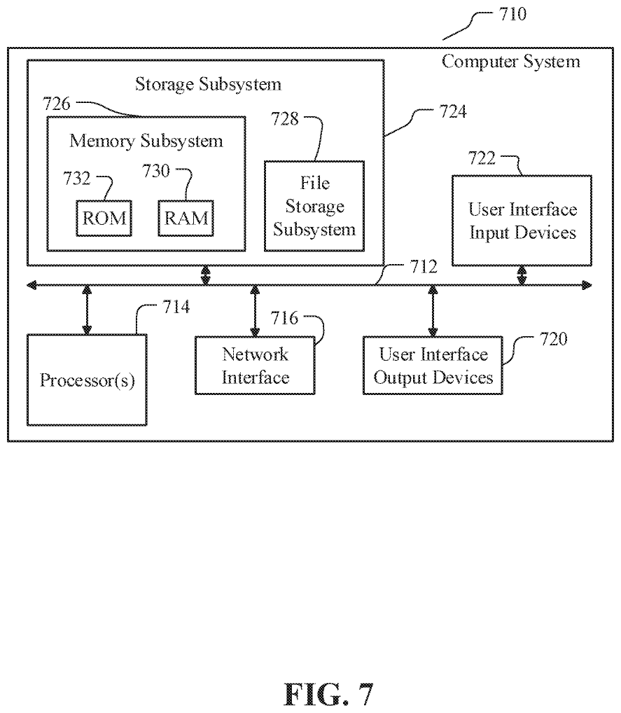

FIG. 7 is a block diagram of an example computer system that can implement the method 200 of FIG. 2 and the method 600 of FIG. 6. Computer system 710 typically includes at least one processor 714, which communicates with a number of peripheral devices via bus subsystem 712. These peripheral devices may include a storage subsystem 724, comprising for example memory devices and a file storage subsystem, user interface input devices 722, user interface output devices 720, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touchscreen incorporated into the display, audio input devices such as speech recognition systems, microphones, and other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the operations described herein. These operations may be implemented by software modules that are generally executed by processor 714 alone or in combination with other processors.

Memory 726 used in the storage subsystem can include a number of memories including a main random access memory (RAM) 730 for storage of instructions and data during program execution and a read only memory (ROM) 732 in which fixed instructions are stored. A file storage subsystem 728 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 728 in the storage subsystem 724, or in other machines accessible by the processor.

Bus subsystem 712 provides a mechanism for letting the various components and subsystems of computer system 710 communicate with each other as intended. Although bus subsystem 712 is shown schematically as a single bus, alternative embodiments of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating the various embodiments. Many other configurations of computer system 710 are possible having more or fewer components than the computer system depicted in FIG. 7.

Various embodiments for generating edited transcriptions in a SR-NLU system have been described in the disclosure. The technology disclosed can be practiced as a method, apparatus or article of manufacture (a non-transitory computer readable medium storing code). An apparatus implementation of the disclosed technology includes one or more processors coupled to memory. The memory is loaded with computer instructions that perform various operations. An article of manufacture implementation of the disclosed technology includes a non-transitory computer readable medium (CRM) storing code that, if executed by one or more computers, would cause the one or more computers to perform various operations. The apparatus implementation and the CRM implementation are capable of performing any of the method implementations described below.

In an implementation, a method for generating an edited transcription of a speech audio is provided. The method may include performing automatic speech recognition on the speech audio to produce a transcription having one or more tokens; interpreting the transcription according to each of a plurality of natural language domains to produce a plurality of interpretation results; identifying, based on the plurality of interpretation results, a natural language domain that matches the transcription; and replacing a token of interest in the transcription with a replacement token according to a predefined mapping specific to the identified natural language domain to generate the edited transcription of the speech audio.

In another implementation, the speech audio is to be updated in real time, and the method for generating an edited transcription of a speech audio may further include performing the automatic speech recognition on the updated speech audio to produce an updated transcription; detecting if the updated transcription includes a new token; and repeating the transcription interpretation, the domain identification and the token replacement for the updated transcription to generate an updated edited transcription once it is detected that the updated transcription includes the new token.

In a further implementation, the transcription may include multiple transcription hypotheses, and interpreting the transcription may include interpreting the multiple transcription hypotheses according to each of the plurality of natural language domains.

In another implementation, the predefined mapping may include a programmatic mapping.

In a further implementation, the predefined mapping may further include a simple token replacement mapping, and the simple token replacement mapping and the programmatic mapping are stored separately in a memory, and the token replacement according to the simple token replacement mapping and the token replacement according to the programmatic mapping are performed simultaneously on separate processing threads.

In another implementation, the predefined mapping may further include a simple token replacement mapping, and the simple token replacement mapping is stored as a search tree in the memory.

In another implementation, the programmatic mapping may include a regular expression mapping.

In another implementation, the predefined mapping may be editable to add, revise or delete a mapping entry in the predefined mapping.

In another implementation, the predefined mapping may be dynamically retrieved over a network from a natural language understanding (NLU) interpreting server.

In a further implementation, the one or more tokens may include alphabetic words including English words, logographic characters including Chinese characters, or discernable elemental units of other types of writing systems.

In another implementation, the replacement token is an abbreviation of the token of interest; the token of interest is a textual expression of a number and the replacement token is the number; the token of interest has a vulgar meaning and the replacement token is a polite synonym of the token of interest; the token of interest is a loan word and the replacement token is a synonym native to a language of the speech audio; or the replacement token has a same pronunciation as the token of interest and a more proper written form than the token of interest in the identified natural language domain.

In another implementation, the token of interest and the replacement token are encoded in different character encodings.

In a further implementation, the method for generating an edited transcription may further include tagging the replacement token within the edited transcription so as to enable rendering the edited transcription with the replacement token being distinguishable.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for generating an edited transcription of a speech audio, the method comprising:
performing automatic speech recognition on the speech audio to produce a transcription having one or more tokens;
interpreting the transcription according to each of a plurality of natural language domains to produce a plurality of interpretation results;
identifying, based on the plurality of interpretation results, a natural language domain that matches the transcription; and
replacing a token of interest in the transcription with a replacement token according to a predefined mapping specific to the identified natural language domain to generate the edited transcription of the speech audio.

2. The method of claim 1, wherein the speech audio is to be updated in real time, and the method further comprises:
performing the automatic speech recognition on the updated speech audio to produce an updated transcription;
detecting if the updated transcription includes a new token; and
repeating the transcription interpretation, the domain identification and the token replacement for the updated transcription to generate an updated edited transcription once it is detected that the updated transcription includes the new token.

3. The method of claim 1, wherein the transcription comprises multiple transcription hypotheses, and interpreting the transcription comprises interpreting the multiple transcription hypotheses according to each of the plurality of natural language domains.

4. The method of claim 1, wherein the predefined mapping comprises a programmatic mapping.

5. The method of claim 4, wherein the predefined mapping further comprises a simple token replacement mapping, and the simple token replacement mapping and the programmatic mapping are stored separately in a memory, and the token replacement according to the simple token replacement mapping and the token replacement according to the programmatic mapping are performed simultaneously on separate processing threads.

6. The method of claim 4, wherein the predefined mapping further comprises a simple token replacement mapping, and the simple token replacement mapping is stored as a search tree in the memory.

7. The method of claim 4, wherein the programmatic mapping comprises a regular expression mapping.

8. The method of claim 1, wherein the predefined mapping is editable to add, revise or delete a mapping entry in the predefined mapping.

9. The method of claim 1, wherein the predefined mapping is dynamically retrieved over a network from a natural language understanding (NLU) interpreting server.

10. The method of claim 1, wherein the one or more tokens comprise alphabetic words including English words, logographic characters including Chinese characters, or discernable elemental units of other types of writing systems.

11. The method of claim 1, wherein:
the replacement token is an abbreviation of the token of interest;
the token of interest is a textual expression of a number and the replacement token is the number;
the token of interest has a vulgar meaning and the replacement token is a polite synonym of the token of interest;
the token of interest is a loan word and the replacement token is a synonym native to a language of the speech audio; or
the replacement token has a same pronunciation as the token of interest and a more proper written form than the token of interest in the identified natural language domain.

12. The method of claim 1, wherein the token of interest and the replacement token are encoded in different character encodings.

13. The method of claim 1, further comprising:
tagging the replacement token within the edited transcription so as to enable rendering the edited transcription with the replacement token being distinguishable.

14. A non-transitory computer readable medium storing code that, if executed by one or more processors, causes the one or more processors to:
perform automatic speech recognition on the speech audio to produce a transcription having one or more tokens;
interpret the transcription according to each of a plurality of natural language domains to produce a plurality of interpretation results;
identify, based on the plurality of interpretation results, a natural language domain that matches the transcription; and
replace a token of interest in the transcription with a replacement token according to a predefined mapping specific to the identified natural language domain to generate the edited transcription of the speech audio.

15. The non-transitory computer readable medium of claim 14, wherein the speech audio is to be updated in real time, and the code, if executed by the one or more processors, causes the one or more processors further to:
perform the automatic speech recognition on the updated speech audio to produce an updated transcription;
detect if the updated transcription includes a new token; and
repeat the transcription interpretation, the domain identification and the token replacement for the updated transcription to generate an updated edited transcription once it is detected that the updated transcription includes the new token.

16. The non-transitory computer readable medium of claim 14, wherein the transcription comprises multiple transcription hypotheses, and the code, if executed by the one or more processors, causes the one or more processors to interpret the transcription by interpreting the multiple transcription hypotheses according to each of the plurality of natural language domains.

17. The non-transitory computer readable medium of claim 14, wherein the predefined mapping comprises a programmatic mapping.

18. The non-transitory computer readable medium of claim 17, wherein the predefined mapping further comprises a simple token replacement mapping, and the simple token replacement mapping and the programmatic mapping are stored separately in a memory, and the token replacement according to the simple token replacement mapping and the token replacement according to the programmatic mapping are performed simultaneously on separate processing threads.

19. The non-transitory computer readable medium of claim 17, wherein the predefined mapping further comprises a simple token replacement mapping, and the simple token replacement mapping is stored as a search tree in the memory.

20. The non-transitory computer readable medium of claim 17, wherein the programmatic mapping comprises a regular expression mapping.

21. The non-transitory computer readable medium of claim 14, wherein the predefined mapping is editable to add, revise or delete a mapping entry in the predefined mapping.

22. The non-transitory computer readable medium of claim 14, wherein the predefined mapping is dynamically retrieved over a network from a natural language understanding (NLU) interpreting server.

23. The non-transitory computer readable medium of claim 14, wherein the one or more tokens comprise alphabetic words including English words, logographic characters including Chinese characters, or discernable elemental units of other types of writing systems.

24. The non-transitory computer readable medium of claim 14, wherein:
the replacement token is an abbreviation of the token of interest;
the token of interest is a textual expression of a number and the replacement token is the number;
the token of interest has a vulgar meaning and the replacement token is a polite synonym of the token of interest;
the token of interest is a loan word and the replacement token is a synonym native to a language of the speech audio; or
the replacement token has a same pronunciation as the token of interest and a more proper written form than the token of interest in the identified natural language domain.

25. The non-transitory computer readable medium of claim 14, wherein the token of interest and the replacement token are encoded in different character encodings.

26. The non-transitory computer readable medium of claim 14, wherein the code, if executed by the one or more processors, causes the one or more processors further to:
tag the replacement token within the edited transcription so as to enable rendering the edited transcription with the replacement token being distinguishable.

27. An apparatus for generating an edited transcription of a speech audio, the apparatus comprising:
a memory; and
a processor to access the memory via a memory interface,
wherein the processor is configured to:
perform automatic speech recognition on the speech audio to produce a transcription having one or more tokens;
interpret the transcription according to each of a plurality of natural language domains to produce a plurality of interpretation results;
identify, based on the plurality of interpretation results, a natural language domain that matches the transcription; and
replace a token of interest in the transcription with a replacement token according to a predefined mapping specific to the identified natural language domain to generate the edited transcription of the speech audio,
wherein the memory is to store a plurality of predefined mappings each of which is respectively specific to each of the plurality of natural language domains.

28. The apparatus of claim 27, wherein the speech audio is to be updated in real time, and the processor is further configured to:
perform the automatic speech recognition on the updated speech audio to produce an updated transcription;
detect if the updated transcription includes a new token; and
repeat the transcription interpretation, the domain identification and the token replacement for the updated transcription to generate an updated edited transcription once it is detected that the updated transcription includes the new token.

29. The apparatus of claim 27, wherein the transcription comprises multiple transcription hypotheses, and the processor is configured to interpret the transcription by interpreting the multiple transcription hypotheses according to each of the plurality of natural language domains.

30. The apparatus of claim 27, wherein the predefined mapping comprises a programmatic mapping.

31. The apparatus of claim 30, wherein the predefined mapping further comprises a simple token replacement mapping, and the simple token replacement mapping and the programmatic mapping are stored separately in a memory, and the token replacement according to the simple token replacement mapping and the token replacement according to the programmatic mapping are performed simultaneously on separate processing threads.

32. The apparatus of claim 30, wherein the predefined mapping further comprises a simple token replacement mapping, and the simple token replacement mapping is stored as a search tree in the memory.

33. The apparatus of claim 30, wherein the programmatic mapping comprises a regular expression mapping.

34. The apparatus of claim 27, wherein the predefined mapping is editable to add, revise or delete a mapping entry in the predefined mapping.

35. The apparatus of claim 27, wherein the predefined mapping is dynamically retrieved over a network from a natural language understanding (NLU) interpreting server.

36. The apparatus of claim 27, wherein the one or more tokens comprise alphabetic words including English words, logographic characters including Chinese characters, or discernable elemental units of other types of writing systems.

37. The apparatus of claim 27, wherein:
the replacement token is an abbreviation of the token of interest;
the token of interest is a textual expression of a number and the replacement token is the number;
the token of interest has a vulgar meaning and the replacement token is a polite synonym of the token of interest;
the token of interest is a loan word and the replacement token is a synonym native to a language of the speech audio; or
the replacement token has a same pronunciation as the token of interest and a more proper written form than the token of interest in the identified natural language domain.

38. The apparatus of claim 27, wherein the token of interest and the replacement token are encoded in different character encodings.

39. The apparatus of claim 27, wherein the processor is further configured to:
tag the replacement token within the edited transcription so as to enable rendering the edited transcription with the replacement token being distinguishable.
